(19) United States
(12) Patent Application Publication
(10) Pub. No.: US 2006/0000540 A1
(43) Pub. Date: Jan. 5, 2006

(54) Apparatus for accurately imprinting unmarked foils

(76) Inventor: Hans Mathea, Eggenstein-Leopoldshafen (DE)

Correspondence Address: KLAUS J. BACH, 4407 TWIN OAKS DRIVE, MURRYSVILLE, PA, 15668, US

(21) Appl. No.: 11/221,044

(22) Filed: Sep. 7, 2005

Related U.S. Application Data
(63) Continuation-in-part of application No. PCT/DE04/00440, filed on Mar. 6, 2004.

(30) Foreign Application Priority Data
Mar. 22, 2003 (DE) 103 12 889.1

(51) Int. Cl. B29C 65/00; B41F 13/56; B32B 31/00; B32B 37/00

(52) U.S. Cl. 156/64; 101/227; 156/277; 156/297

(57) ABSTRACT

In an apparatus for accurately applying elements to an unmarked first foil and joining the first foil with a second foil which includes marks at a predetermined distance from one another, wherein the elements need to be applied to the first foil in a predetermined relationship to the marks of the second foil and wherein a connecting device is provided for joining the two foils, a transport device for jointly advancing the two foils and an application device by which the elements are applied to the first foil when an activation signal is provided thereto, a sensor is arranged along the second foil for generating the activation signal when sensing the presence of the marks on the second foil.

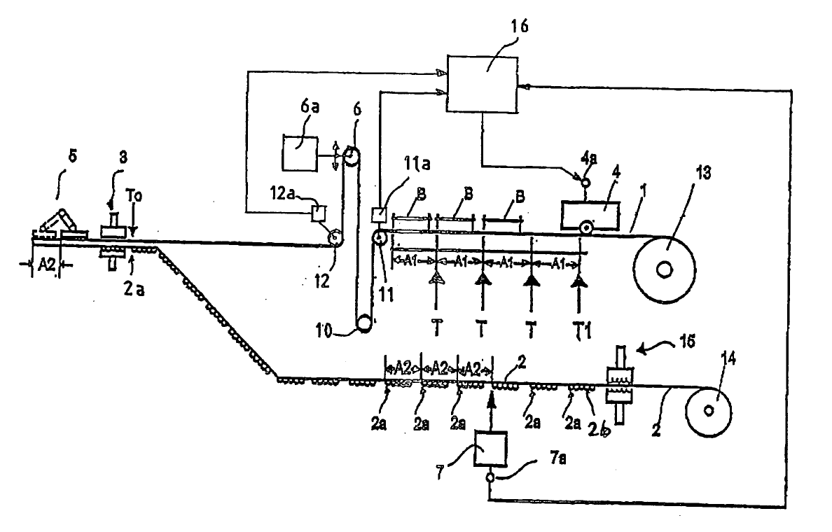

This is a Continuation-In-Part Application of International Application PCT/EP2004/000440 filed Mar. 6, 2004 and claiming the priority of German Application 103 12 889.1 filed Mar. 22, 2003.

### BACKGROUND OF THE INVENTION

The invention relates to an apparatus for accurately imprinting a first foil which, in sections of a certain section length A1, includes imprints or elements B and which is to be joined to a second foil which includes marks spaced by a predetermined distance corresponding to the certain section length. The elements must be accurately placed onto the first foil with respect to the marks using a first device by which the two foils are advanced stepwise by the section length and another device with an activation input by which an element is applied to the first foil when a signal is applied to the input of the other device.

Such an apparatus is used for example in the manufacture of so-called blister packs in which for example tablets are distributed. A blister pack consists generally of a deep-draw foil of plastic or paper which is provided with depressions in which the tablets are disposed and which are covered by a cover foil. On the cover foil, there is generally an imprint with information concerning the tablets contained in the blister pack such as data when which tablets have to be taken. It is therefore very important that this information is applied in accordance with the position of the tablets and that the depressions are accurately positioned with respect to the imprints on the cover foil.

Although with the printing techniques known today a very high printing accuracy is achieved the position-accurate coordination of the imprint of the cover foil and the deep-draw foil is problematic since deviations, although small, add up. In time therefore, the position of an imprint could deviate from the required position by an intolerable amount. Therefore printing apparatus have been developed with which the position accuracy of the imprints on the cover foil has been substantially increased. DE 195 25 713 C1, (applicants U.S. Pat. No. 5,964,151) for example, discloses an apparatus for the position accurate imprinting of an unmarked endless foil by which imprints of a first predetermined length are applied to a metal foil wherein, after being imprinted, the foil is cut into sections of a second predetermined length by a cutting machine and the imprints are accurately applied to the foil based on the separating locations between the sections.

In this type of apparatus, a printer is used which has an input for initiating a position-accurate imprinting step. Furthermore, a sensor is present which provides, at its output, a signal whenever the length of the foil between the cutting machine and the location corresponding to the beginning of a section to be imprinted is a multiple of the second predetermined length.

Since the output of the sensor is connected to the printer, the beginning of a section of the foil to be imprinted is always newly determined. Since the beginning of a section to be imprinted is always newly determined, possible errors are not added up. Consequently, even a relatively large deviation is generally not detrimental since the deviation present in one section does not affect the determination of the beginning of the next section to be imprinted.

Furthermore, DE 198 50 275 (applicants U.S. Pat. No. 6,164,200), discloses another apparatus for the position-accurate imprinting of an unmarked endless foil which is based essentially on the same principle as the apparatus disclosed in the earlier mentioned patent. The main difference resides in the fact that in the imprinting apparatus of DE 195 25 713 C1 the endless foil is moved in a stepwise fashion, whereas in DE 198 50 275, the foil movement is continuous. However, the printer is also activated when the length of the endless foil between the respective last provided section limit and the printing apparatus is a predetermined multiple of the second predetermined length.

Although excellent results are obtained with the known apparatus, it has been found that the imprint can still be displaced with regard to the impression because of outside influences: Particularly after a shut-down of the apparatus deviations have been noticed which are not tolerable.

It is the object of the present invention to provide an apparatus for position-accurately imprinting an endless foil in such a way that position changes of the elements applied to the first foil relative to the marks applied to the second foil to which the first foil is to be applied are very small under any conditions.

### SUMMARY OF THE INVENTION

In an apparatus for accurately applying elements to an unmarked first foil and joining the first foil with a second foil which includes marks at a predetermined distance from one another, wherein the elements need to be applied to the first foil in a predetermined relationship to the marks of the second foil and wherein a connecting device is provided for joining the two foils, a transport device for jointly advancing the two foils and an application device by which the elements are applied to the first foil when an activation signal is provided thereto, a sensor is arranged along the second foil for generating the activation signal when sensing the presence of the marks on the second foil.

With the provision of a sensor for sensing the marks of the second foil, which sensor supplies a signal to the second device when it senses a mark of the second foil a synchronization of the elements applied to the first foil with the marks of the second foil is achieved in a simple manner. As a result, if there is a difference between the predetermined distance between two subsequent marks of the second foil with respect to the section lengths of the sections of the first foil, the element is applied to the first foil displaced by the same difference. In subsequent sections of the first foil the elements are then deposited displaced with respect to the boundary between adjacent sections corresponding to the respective difference. It is therefore no longer necessary to provide for further corrections.

It is particularly advantageous if the apparatus according to the invention is used for the position-accurate joining of an aluminum foil provided with an imprint and a plastic foil including impressions for accommodating for example tablets.

A particularly advantageous embodiment of the invention resides in an arrangement with an offset structure by which the length of the first foil between the first device and the second device can be adjusted. With the offset structure, the position of the element with respect to the boundary between two adjacent sections can be changed in a simple way. Such a change may for example be necessary if the length of the first foil between the first device and the second device or the length of the second foil between the first device and the sensor has changed for example by material expansion or shrinkage. Furthermore, the arrangement can be adjusted by the offset structure in a simple manner during startup operation. The offset structure may be a mechanical device or it may be in the form of an electronic circuitry by which an offset to be corrected can be computationally corrected.

The arrangement according to the invention has furthermore the advantage that, with a format change, that is a change of the predetermined distance between the markings of the second foil and a corresponding change in the length of the sections of the first foil no special measures must be taken. It will only be necessary to re-position the sensor in accordance with the new spacing of the markings.

With the simple design according to the invention, the operational reliability of the apparatus is also increased.

In another advantageous embodiment of the invention, an element for transporting the first foil is disposed, in the transport direction of the first foil ahead of, and after, the offset structure. With the transport elements arranged in this way, the length of the foil between the transport elements can be adjusted in a simple manner. This is advantageous during servicing or during start-up operations. In the last-mentioned embodiment, the transport elements are preferably provided with the transducers by which the transported foil length is determined. In this way, it can be determined whether the length of the foil transported ahead of the offset structure equals the length of the foil transported after the offset structure. If the two lengths do not coincide, an undesirable displacement of the position of the element on the first will result.

Consequently, in a further embodiment of the invention, a control arrangement is provided by way of which the activation signal of the second device can be delayed depending on the transducer signals. If, for example, the length of the foil transported by the transport element disposed ahead of the offset structure is less than that transported by the transport element disposed after the offset structure, the signal supplied by the sensor is delayed by a corresponding time so that the signal applied to the second device is delayed in such a way that the element is applied to the first foil in a proper position.

With the apparatus according to the invention, the position accuracy of an imprint can be maintained or easily and rapidly be re-established, particularly after a shut-down of the blister packaging machine, when the position of an imprint on the first foil is generally displaced with respect to the is rapidly readjusted so as to operate again with high accuracy.

The invention will become more readily apparent from the following description of a preferred embodiment thereof with reference to the accompanying drawings.

### BRIEF DESCRIPTION OF THE DRAWINGS

The sole FIGURE is a schematic representation of the unmarked foil imprinting apparatus according to the invention.

### DESCRIPTION OF A PREFERRED EMBODIMENT

As shown in the FIGURE, a first foil 1 in the form of an aluminum foil is joined in a connecting station 3 to a second foil 2 in the form of a plastic foil. The plastic foil is provided with impressions forming cavities 2b. Several cavities 2b are combined in a group of which the front edge of the—in transport direction—first cavity 2b represents a marking 2a. The markings 2a are disposed at a predetermined distance A2 from one another.

The cavities 2b are embossed into the plastic foil 2 by a stamping tool 15 as the plastic foil is rolled off a roll 14.

In a filling station, which is not shown in the FIGURE, tablets are placed into the cavities 2b. After the placement of the tablets into the cavities 2b, the cavities are closed by the aluminum foil 1 and sealed. In this way, a so-called blister pack is formed. Since such blister packs always need to include information, the aluminum foil 1 is provided with imprints B which must be accurately positioned relative to the cavities 2b.

For imprinting the aluminum foil 1, which is unwound from a roll 13, the foil 1 is guided through a printer 4. For the initiation of a position-accurate printing procedure, the printer 4 has an input 4a.

In transport directions after the printer 4, the aluminum foil 1 is guided around a first reversing roller 11, which forms a first transport element. After the reversing roller 11, the aluminum foil 1 extends in an S-configuration around a dancing roller 10 and an offset roller 6. The dancing roller 10 and the offset roller 6 are each disposed in opposite loops formed by the aluminum foil 1. After the offset roller 6, the aluminum foil 1 extends around a second reversing roller 12 which forms a second transport element. In the transport direction of the aluminum foil after the second reversing roller 12, there is a transport device 5 by which the aluminum foil 1 is advanced stepwise by a predetermined length A2 of the marks 2a of the plastic foil 2. Normally, the length of a section in which the imprint must be accurately positioned corresponds to the predetermined distance A2 of the marks 2a of the plastic foil. Between the sections, there is an imaginary dividing line T.

The first reversing roller 11 is connected to a transducer 11a by which the length of the aluminum foil 1 moved around the first reversing roller 11 can be determined. The second reversing roller 12 is connected to a second transducer 12a by which the length of the aluminum foil 1 moved around the second reversing roller 12 can be determined. The reversing rollers 11, 12 may include drive means for the transport of the aluminum foil 1.

Ahead of the transport device 5 a joining and sealing device 3 is provided in which the aluminum foil 1 is joined to the plastic foil 2. The subsequent transport device 5 advances the compound foil consisting of the plastic foil and the aluminum foil.

The two foils 1, 2 are advanced by the transport device 5 until the mark 2a formed by the front edge of one of the first impressions of the second foil 2 reaches a fixed point TO of the connecting station 3. That is, the two foils 1, 2 are each advanced until the front edge 2a of the first depression of the next group of impressions 2a reaches the fixed point TO. Since the front edges 2a are disposed at a predetermined distance from each other, both foils 1, 2 are moved on by the predetermined distance A2.

The dancer roller 10 and the offset roller 6 are so arranged that they can be moved toward, or away from, one another. While the offset roller 6 can be held in a particular position and is movable only by means of an adjusting unit 6a, the dancer roller 10 is freely movable.

In transport direction of the plastic foil 2, a sensor 7 is arranged after the stamping tool 15 by which the front edge of a mark 2a formed by the impression 2b can be determined. When the sensor 7 senses the front edge 2a of the first depression of a group of depressions, the sensor provides a signal. The sensor 7 is so arranged that the length of the plastic foil 2 between the fixed point TO and the reference point of the sensor 7 is a predetermined multiple of the distance A2 between the marks 2a.

If the compound foil consisting to the two foils 1, 2 is advanced via the transport device 5 a corresponding length of the second foil 2 is moved through the stamping tool 15. Furthermore, the same length of the aluminum foil 1 is moved through the printer 4. To this end, the first transport element 11 is driven in accordance with the signals provided by the second transducer 12a of the second transport element 12. The aluminum foil is therefore moved through the printer synchronously with the movement of the plastic foil 2 through the stamping tool 15. That means that, with a corresponding arrangement of the sensor 7, the length of the first foil 1 disposed between the fixed point TO and the reference point T1 of the printer 4 corresponds to the length of the second foil 2 between the fixed point TO and the sensor 7.

When the sensor detects a first impression of a group of impressions 2b of the plastic foil 2 which forms the mark 2a, the signal at the output of the sensor 7 is transmitted by the control unit 16to the input 4a of the printer 4. As a result, the printer 4 prints onto the aluminum foil an image which is positioned in relation to the mark 2a.

If the distance A2 between the marks 2a of the plastic foil 2 changes by a certain length as it may happen during a shut-down of the apparatus by temperature effects or by stretching or shrinking of the plastic foil 2, the sensor 7 detects the mark 2a correspondingly later or earlier so that the imprinting step is initiated correspondingly later or earlier. As a result, the position of the imprint on the aluminum foil 1 30 relative to the position of the impressions 2b of the plastic foil 2 remain correctly placed.

If it is determined by the two transducers 11a and 12a that the length of the aluminum foil 1 being moved through the printer 4 becomes smaller than the length being advanced by the transport device 5, the control unit 16 delays the signal provided by the sensor 7 until the lengths are the same, that is the length of the aluminum foil 1 between the fixed point TO of the connecting station 3 and the printer 4 is the same as the length of the plastic foil 2 between the fixed point TO of the connecting station 3 and the sensor 7

It is noted that, in connection with the apparatus according to the invention, any type of printer may be used, particularly a so-called plate printer, flexoprinter or screen printer.

It is also not necessary that the foils are transported discontinuously in steps as shown in the disclosed embobiment. The invention may as well be used in connection with an apparatus in which the foils or materials webs are moved continuously as this is done in DE 198 50 275 A1 (Applicants U.S. Pat. No. 6,164,200).

What is claimed is:

1. An apparatus for accurately applying to sections of a length (A1) of an unmarked first foil (1) elements (B) and joining the first foil with a second foil (2), said second foil (2) including marks (2a) disposed at a predetermined distance (A2) from one another corresponding to a section length (A1) of said unmarked first foil (1), except for a possible difference, wherein said elements (B) need to be applied to the first foil (1) accurately in a predetermined relation to said marks (2a) of said second foil, said apparatus including a connecting device (3) for joining the two foils (1, 2), a transport device (5) for jointly advancing the two interconnected foils (1, 2) by the predetermined distance (A2), an application device (4) including an activation input (4a) by which an element (B) is applied to the first foil (1) when a signal is applied to the activation input (4a) and a sensor (7) arranged along the second foil so as to sense the presence of the marks (2a) of the second foil (2) and providing a signal to the activation input (4a) of the application device (4) for initiating the application of the element (B) to the first foil (1).

2. An apparatus according to claim 1, wherein the element B applied to the first foil 1 is an imprint, said first foil is an aluminum foil to which the imprint is applied and the second foil (2) is a plastic foil provided with embossed impressions (2b).

3. An apparatus according to claim 1, including an offset structures (6) by which the length of the first foil (1) between the connecting device (3) and the application device (4) is adjustable.

4. An apparatus according to claim 3, wherein, in transport direction of the first foil (1) ahead of, and after, the offset structure (6), a transport member (11, 12) is provided for moving the first foil (1).

5. An apparatus according to claim 4, wherein the transport members (11, 12) include each a reversing roller with a transducer (11a, 12a) for determining the transport length of said first foil (1).

6. An apparatus according to claim 5, wherein a control unit (16) is provided by way of which the activation signal for the application device (4) can be delayed or advanced depending on the length of the first foil (1) between the application device (4) and the connecting device (3) and the length of the second foil (2) between the sensor (7) and the connecting device (3).
